(19) United States
(12) Patent Application Publication
(10) Pub. No.: US 2026/0356401 A1
(43) Pub. Date: Nov. 12, 2026

(54) METHOD AND SYSTEM FOR REMOTELY UPDATING AND VERIFYING MUNICIPAL RAIL TRANSIT LINE MAP DATA

(71) Applicant: CASCO SIGNAL LTD., Shanghai (CN)

(72) Inventors: Donghai WANG, Shanghai (CN); Tao HAN, Shanghai (CN); Ming CHANG, Shanghai (CN); Huaxiang LIU, Shanghai (CN); Xiaoyong WANG, Shanghai (CN); Xiaoque LING, Shanghai (CN)

(73) Assignee: CASCO SIGNAL LTD., Shanghai (CN)

(21) Appl. No.: 19/124,882

(22) PCT Filed: Nov. 16, 2023
(86) PCT No.: PCT/CN2023/131983

§ 371 Date: Apr. 27, 2025

(30) Foreign Application Priority Data
Dec. 30, 2022 (CN) 202211734971.X

(51) Int. Cl. B61L 15/00; G01C 21/00; G06F 16/29; H04W 4/44; H04W 4/46

(52) U.S. Cl. CPC B61L 15/0072; G01C 21/387; G01C 21/3889; G01C 21/3896; H04W 4/44; H04W 4/46; G06F 16/29

(57) ABSTRACT

A method and a system for remotely updating and verifying municipal rail transit line map data. The method is applied to a vehicle-mounted controller, the vehicle-mounted controller is respectively in communication connection with a line data storage unit and a global download server, and the method comprises the following steps: when a verification instruction is received, judging whether a utilized data version is consistent with an authorized version, the authorized version being stored in the line data storage unit; if so, then updating is not needed, but if not, then automatically downloading updated map data corresponding to the authorized version, the updated map data being stored in the global download server.

### TECHNICAL FIELD

The present disclosure relates to the field of urban rail transit communication technologies, in particular to a method and system for remotely updating and verifying map data of urban rail transit lines.

### BACKGROUND

With the acceleration of urbanization, cities are becoming more and more closely integrated with suburbs and with each other. The development of metropolitan areas calls for an integrated transportation solution featuring multi-network integration and interoperability. Urban rail transit lines and their operational characteristics fall between intercity rail transit and urban rail transit, with target speeds of 120 km/h to 160 km/h and single-line lengths of approximately 80 km. The operation mode is generally networked and public transportation operation, exemplified by projects such as the Shenzhen-Dayawan and Shenzhen-Huizhou intercity lines under construction in the Shenzhen metropolitan area and multiple urban rail transit lines with a “one trunk and multiple branches” structure in the Xiong'an New Area. The cross-line train interoperation, the combined operation of long and short routes, and the highly flexible networked operation organization mode are the intrinsic demands of urban railway construction and also the primary issues to be considered in the research and development of related train control equipment.

For the construction of an urban rail transit line network, the train operation control system is generally a communication-based train control (CBTC) system or a combination of the CBTC system and a Chinese train control system (CTCS). Train localization relies on an on-board electronic map. To achieve cross-line operation of urban rail transit trains in the network, before the train enters a specific line, the vehicle on-board controller needs to obtain electronic map data of the line and its version. The train is only permitted to enter the line after the on-board electronic map is correctly loaded and its version is verified to be consistent with that of the track side train control equipment in the zone. Therefore, the vehicle on-board controller needs to implement the functions of remotely updating and verifying the electronic map. However, there are still some deficiencies in the implementation of remote update and verification of the existing electronic map, such as untimely update and lower reliability.

### SUMMARY OF THE INVENTION

An objective of the present disclosure is to provide a method and system for remotely updating and verifying map data of urban rail transit lines, which have good applicability and ensure reliability, so as to overcome the above defects in the prior art.

The objective of the present disclosure can be achieved by the following technical solutions:

A method for remotely updating and verifying map data of urban rail transit lines, applied in a vehicle on-board controller communicatively connected to a line data storage unit and a global download server separately, and including the following steps:
when a verification instruction is received, determining whether a data version in use is consistent with an authorized version stored in the line data storage unit: if the data version in use is consistent with the authorized version, skipping updating; or if the data version in use is not consistent with the authorized version, automatically downloading updated map data corresponding to the authorized version, where the updated map data is stored in the global download server.

Further, the verification instruction is generated during power-on process or before cross-line operation.

Further, during power-on process, verification is performed only by comparing with an authorized version stored in a line data storage unit of a current line.

Further, during power-on process, it is determined whether operation plan information is received: if the operation plan information is received, verification is performed by comparing with an authorized version stored in a line data storage unit of a line along a route based on the operation plan information.

Further, before cross-line operation, it is determined whether a pre-establish-communication zone is reached: if the pre-establish-communication zone is reached, verification is performed by comparing with an authorized version stored in a line data storage unit of a next line to be entered.

Further, the method further includes a communication failure determination approach, which specifically includes the following sub-steps:
1a): during operation, determining in real time whether a communication failure exists on a current line: if the communication failure exists on the current line, executing sub-step 1b); or if the communication failure does not exist on the current line, repeating sub-step 1a); and
1b): determining whether a failure exists on an adjacent line: if the failure exists on the adjacent line, entering a backup mode for cross-line operation; or if the failure does not exist on the adjacent line, entering the adjacent line for operation, and performing verification by comparing with an authorized version stored in a line data storage unit of the adjacent line.

Further, the method further includes a train-to-train communication approach, which specifically includes the following sub-steps:
2a): determining whether a train-to-train communication mode is activated: if the train-to-train communication mode is activated, executing sub-step 2b); or if the train-to-train communication mode is not activated, repeating sub-step 2a); and
2b): sending a request to acquire latest map data to a front train, and updating data of a current train based on an obtained response from the front train.

Further, in the train-to-train communication mode, statuses of reliable nodes are acquired, and it is determined whether the data version in use is consistent with an authorized version of any one of the reliable nodes: if the data version in use is consistent with the authorized version of any one of the reliable nodes, skipping updating; or if the data version in use is not consistent with the authorized version of any one of the reliable nodes, automatically downloading updated map data corresponding to the authorized version from any one of the reliable nodes, where each of the reliable nodes includes a line data storage unit of a current line or other vehicle on-board controllers.

Further, when the global download server updates the map data, a latest data version of the updated map data is simultaneously stored in the line data storage unit.

Further, when there exists a communication failure exceeding an allowable range of system security time, the global download server locks data updating.

Further, during operation, the global download server locks data updating.

Further provided in the present disclosure is a vehicle on-board controller, including a memory and a processor, where the memory stores a computer program, and when the computer program is executed by the processor, the method for remotely updating and verifying map data of urban rail transit lines as described above is implemented.

Further provided in the present disclosure is a computer-readable storage medium, storing a computer program, where when the computer program is executed by one or more processors, the method for remotely updating and verifying map data of urban rail transit lines as described above is implemented.

Further provided in the present disclosure is a system for remotely updating and verifying map data of urban rail transit lines, including a vehicle on-board controller, a line data storage unit, and a global download server, the vehicle on-board controller being communicatively connected to the line data storage unit and the global download server separately, where the global download server is configured to store latest map data;
the line data storage unit is configured to store a latest data version of the map data, where the latest data version is an authorized version; and
the vehicle on-board controller is configured to determine, when receiving a verification instruction, whether a data version in use is consistent with the authorized version stored in the line data storage unit: if the data version in use is consistent with the authorized version stored in the line data storage unit, skip updating; or if the data version in use is not consistent with the authorized version stored in the line data storage unit, automatically download updated map data corresponding to the authorized version from the global download server.

Further, a unique line data storage unit is set up for each line, and the vehicle on-board controller, before cross-line operation, determines whether a pre-establish-communication zone is reached: if the pre-establish-communication zone is reached, verification is performed by comparing with an authorized version stored in a line data storage unit of a next line to be entered.

Further, the vehicle on-board controller has a train-to-train communication mode in which a request to acquire the latest map data is sent to a front train, and data of a current train is updated based on an obtained response from the front train.

Further, in the train-to-train communication mode, the vehicle on-board controller acquires statuses of reliable nodes and determines whether the data version in use is consistent with an authorized version of any one of the reliable nodes: if the data version in use is consistent with the authorized version of any one of the reliable nodes, updating is skipped; or if the data version in use is not consistent with the authorized version of any one of the reliable nodes, updated map data corresponding to the authorized version is automatically downloaded from any one of the reliable nodes, where each of the reliable nodes includes a line data storage unit of a current line or other vehicle on-board controllers.

Further, when there exists a communication failure exceeding an allowable range of system security time, the global download server locks data updating.

Further, during operation, the global download server locks data updating.

Further, the vehicle on-board controller, the line data storage unit, and the global download server achieve communication via a WiFi network or a 5G network.

Compared with the prior art, the present disclosure has the following beneficial effects:
1) According to the present disclosure, online dynamic data updating can be achieved, thereby solving the technical problems of management and application of static data electronic maps for urban rail transit.
2) The present disclosure is designed in accordance with the design architecture of the existing interoperable communication-based train control (CBTC) products and is implemented by designing software modules with corresponding functions. Additional hardware products or hardware designs are not required. The method features good applicability, incurs no additional hardware cost, and does not reduce the system reliability.
3) According to the present disclosure, the pre-establish-communication zone is set up before cross-line operation to ensure the minimum system update time and improve the reliability of data updating.
4) According to the present disclosure, a special data service node network is set up according to the road network or operation requirements. For example, it is proposed to optimize the data downloading method at cross-line stations under the application conditions of additional WiFi channels or 5G technology.
5) According to the present disclosure, line data can be updated based on the train-to-train communication technology. Through the multi-point downloading of line map data and the verification function of multiple secure and reliable nodes, the system availability is maximally improved on the premise of ensuring the security integrity level of the entire system. A more efficient line map data update mechanism is provided based on the train-to-train communication mechanism. The vehicle on-board controller (VOBC) of the front train serves as a reliable node of the system, and its map data can be used by the rear train. The rear train can complete data updating without downloading data through the global download server (GLDS). Meanwhile, the multiple data verification mechanism established with multiple reliable nodes can maximally improve the system availability, and the reverse locking mechanism for downloading of line map data ensures the consistency of the map data and the system security.

### BRIEF DESCRIPTION OF THE DRAWINGS

FIG. 1 is a schematic diagram of a system architecture adopted in an embodiment of the present disclosure;

FIG. 2 is a timing diagram of in-depot data updating in an embodiment of the present disclosure;

FIG. 3 is a schematic diagram of data updating before line crossing in an embodiment of the present disclosure;

FIG. 4 is a schematic diagram of downloading of map data based on train-to-train communication in an embodiment of the present disclosure;

FIG. 5 is a schematic diagram of collaborative verification based on multi-node secure and reliable devices in an embodiment of the present disclosure; and

FIG. 6 is a schematic diagram of a reverse locking mechanism for downloading of line map data in an embodiment of the present disclosure.

### DETAILED DESCRIPTION OF THE EMBODIMENTS

The present disclosure is described in detail below with reference to the drawings and specific embodiments. This embodiment is implemented on the premise of the technical solutions of the present disclosure, providing detailed implementations and specific operational procedures. However, the scope of protection of the present disclosure is not limited to the following embodiments.

When map data of a certain line changes, such as line extension or structural changes, or when a train controller does not store a map of the line but a train needs to enter the line for operation according to a daily operation plan, or before the train needs to cross lines suddenly to enter the line for operation due to a change in the operation plan, a trackside controller should timely inform all vehicle on-board controllers that may enter the zone, instructing them to update line data in advance, or the vehicle on-board controller should actively request update of the line data and pass system security verification to ensure that the on-board electronic map is consistent with the trackside line data, thereby guaranteeing the safety of cross-line train operation. The present disclosure is proposed based on the above requirements.

### Embodiment 1

Provided in this embodiment is a method for remotely updating and verifying map data of urban rail transit lines, applied in a vehicle on-board controller communicatively connected to a line data storage unit and a global download server separately, and including the following steps: when a verification instruction is received, determining whether a data version in use is consistent with an authorized version stored in the line data storage unit: if the data version in use is consistent with the authorized version, skipping updating; or if the data version in use is not consistent with the authorized version, automatically downloading updated map data corresponding to the authorized version, where the updated map data is stored in the global download server.

Specifically, when the global download server updates the map data, a latest data version of the updated map data is simultaneously stored in the line data storage unit. When there exists a communication failure exceeding an allowable range of system security time, the global download server locks data updating. Meanwhile, during operation, the global download server locks data updating. Through the above reverse locking mechanism, it is ensured that trackside data will not be erroneously refreshed due to misoperation or human factors, thereby improving security and reliability.

The verification instruction can be generated during power-on process or before cross-line operation. During power-on process, verification is performed only by comparing with an authorized version stored in a line data storage unit of a current line. Meanwhile, during power-on process, it is determined whether operation plan information is received: if the operation plan information is received, verification is performed by comparing with an authorized version stored in a line data storage unit of a line along a route based on the operation plan information. Before cross-line operation, it is determined whether a pre-establish-communication zone is reached: if the pre-establish-communication zone is reached, verification is performed by comparing with an authorized version stored in a line data storage unit of a next line to be entered.

In another embodiment, the method further includes a communication failure determination approach, which specifically includes the following sub-steps: 1a): during operation, determining in real time whether a communication failure exists on a current line: if the communication failure exists on the current line, executing sub-step 1b); or if the communication failure does not exist on the current line, repeating sub-step 1a); and 1b): determining whether a failure exists on an adjacent line: if the failure exists on the adjacent line, entering a backup mode for cross-line operation; or if the failure does not exist on the adjacent line, entering the adjacent line for operation, and performing verification by comparing with an authorized version stored in a line data storage unit of the adjacent line.

In another embodiment, the method further includes a train-to-train communication step, which specifically includes the following sub-steps: 2a): determining whether a train-to-train communication mode is activated: if the train-to-train communication mode is activated, executing sub-step 2b); or if the train-to-train communication mode is not activated, repeating sub-step 2a); and 2b): sending a request to acquire latest map data to a front train, and updating data of a current train based on an obtained response from the front train.

Specifically, in the train-to-train communication mode, statuses of reliable nodes are acquired, and it is determined whether the data version in use is consistent with an authorized version of any one of the reliable nodes: if the data version in use is consistent with the authorized version of any one of the reliable nodes, skipping updating; or if the data version in use is not consistent with the authorized version of any one of the reliable nodes, automatically downloading updated map data corresponding to the authorized version from any one of the reliable nodes, where each of the reliable nodes includes a line data storage unit of a current line or other vehicle on-board controllers.

If the above method is implemented in the form of a software functional unit and sold or used as an independent product, it can be stored in a computer-readable storage medium. Based on such an understanding, the technical solution of the present disclosure, in essence, or the part that makes contributions to the prior art, or part of the technical solution may be embodied in the form of a software product. The computer software product is stored in a storage medium and includes a plurality of instructions for causing a computer device (that may be a personal computer, a server, or a network device) to execute all or some of the steps of the methods described in the various embodiments of the present disclosure. The aforementioned storage medium includes various media that can store program codes, such as a USB flash drive, a portable hard drive, a read-only memory (ROM), a random access memory (RAM), a magnetic disk, or a compact disc.

### Embodiment 2

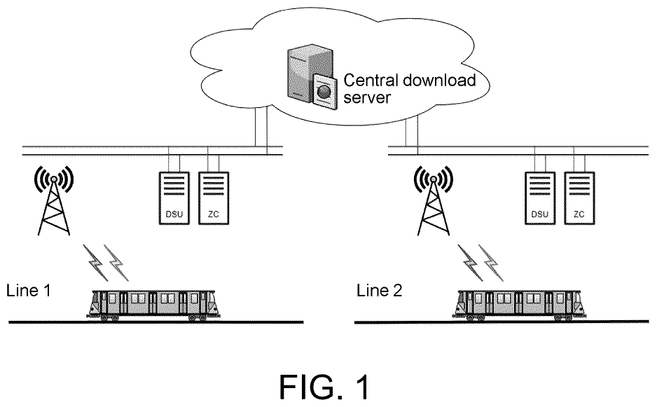

Provided in this embodiment is a system for remotely updating and verifying map data of urban rail transit lines, which implements the method as described in Embodiment 1. The system functions are allocated at three levels: a control center, a line, and on-board equipment. Specifically, the system includes a global download server (GLDS, marked as a central download server in the figure) of a networked control center, a data storage unit (DSU) of a single line, a zone controller (ZC), and a vehicle on-board controller (VOBC), as shown in FIG. 1.

### I. Function Allocation of Communication System:

### 1. GLDS

A unique GLDS is set up in the networked control center to upload electronic map data of all lines in the entire line network and synchronously manage data in the DSUs of the lines.

To achieve the remote update function for the electronic map data, the GLDS should implement the following functions:
The GLDS should be able to allow wireless access by all VOBCs in the line network.
The GLDS should be able to store data of VOBCs from all manufacturers in the line network.
The GLDS should be able to provide means (which require corresponding procedures for guarantee) for signal manufacturers of all lines to upload line data required by their respective VOBCs.
The GLDS should be able to provide means to distinguish data from different manufacturers.

### 2. DSU of Single Line

A unique DSU is set up for each line to synchronize data between the VOBC operating on or intending to operate on the line and the ZC of the line. It also communicates with the VOBC operating within the scope of the line to authorize a data version within the scope of the line.

To achieve the remote update function for the electronic map data, the DSU should implement the following functions:
The DSU should be able to establish secure communication with all VOBCs that may enter the line.
The DSU should be able to securely store the data version authorized by the line.
The DSU should be able to securely exchange information of the authorized data version with the VOBCs.

### 3. ZC

Several ZCs are set up on each line according to the size of a control zone and the system capability. They interact in real time with the VOBCs regarding an electronic map version of the zone to ensure the consistency and correctness of the electronic map version.

### 4. VOBC

The VOBC synchronizes the electronic map data and other data with the GLDS. The VOBC of each train performs security verification with the DSU of the line it is on to ensure that the data version in use is authorized. The VOBC of each train performs security verification with the ZCs in the current zone and an overlapping area to ensure that the electronic map version in use is consistent with that of the current ZC.

To achieve the remote update function for the electronic map data, the VOBC should implement the following functions:

The VOBC should verify whether the electronic map version currently in use is consistent with that of the ZC when establishing communication with the ZC: If they are inconsistent, it prohibits the use of movement authority (MA) information sent by the ZC.

The VOBC should be able to establish communication with the GLDS to download the required data.

The VOBC should be able to check the integrity and correctness of the downloaded data.

The VOBC should be able to dynamically load new data online and use the data directly without restarting, which will not affect the normal operation of the train.

The VOBC should be able to establish secure communication with the DSU to verify whether the data version in use is authorized by the DSU.

The VOBC should be able to store data of multiple lines and load it when needed, but it should only use the data after passing the version verification with the DSU.

If the data currently used by the VOBC has been verified by the DSU and the communication with the DSU is interrupted, the VOBC can continue to use the data as long as it does not lose power.

To improve the system availability and prevent the VOBC from being unable to continue operation due to interruption of communication with the DSU during operation, the data previously verified by the VOBC and the DSU can continue to be used as long as the VOBC remains online.

To ensure the security and consistency of the line data, without adopting an additional protection mechanism (e.g., a data reverse locking mechanism), the following operational restriction conditions need to be output:

Output restriction 1: trackside line data should not be updated during operation hours.

Output restriction 2: After the line data is updated, it should be manually ensured that all VOBCs that need to operate on the line re-download the data and pass verification of a new data version by the DSU, which can be achieved by remotely restarting the VOBCs.

Interoperability-related interfaces among the above equipment are as shown in Table 1.

TABLE 1
Interoperability-related interfaces

| | Interface | Security- | |
|---|---|---|---|
| Interface | protocol | related | Description |
| VOBC-DSU | TCP/IP | Yes | Data version verification information |
| | RSSP-I | | |
| VOBC-GLDS | TCP/IP | No | For application of data, a standard TFTP |
| | TFTP | | interface can be used. |
| DSU-GLDS | TCP/IP | No | For application of data version information, |
| | TFTP | | when new data is manually uploaded to the |
| | | | “central download server”, the authorized |
| | | | version in the DSU needs to be |
| | | | synchronously updated to ensure their |
| | | | consistency. |

### II. Performance Estimation of Communication System

Estimation is performed according to a train-ground interface under the architecture of a fully automatic operation (FAO) interoperable system. Under normal conditions, the bandwidth requirements of wireless communication for a train-ground control instruction (excluding maintenance information) are as follows:

From the VOBC to trackside equipment, the total uplink data volume is 2.5 kilobytes per second (approximately 20 kbps).

From the trackside equipment to the VOBC, the downlink data volume is approximately 4.3 kilobytes per second (approximately 35 kbps).

According to the definition in “T_CAMET 04006.4-2018 Long Term Evolution for Metro (LTE-M) Interface Specification Part 4: CBTC Service Bearing and Interface”, for FAO projects, the uplink and downlink bandwidths of wireless communication for a single train should each be guaranteed at 512 kbps.

Herein, assuming that configuration data of the VOBC is 5 megabytes (depending on the line length, complexity, and whether to download by zone), if a bandwidth of 400 kbps is occupied for downloading, it will take 100 seconds. Considering the time for re-transmission due to failure during downloading, and the time for subsequent verification and dynamic loading, it is conservatively estimated to take 3-5 minutes. Therefore, the following requirements need to be added:

During system design, the time required for remote update of the VOBC should be considered.

During early morning power-on in a depot, the time for remote update should be reserved.

At a line boundary where line crossing is required, a sufficiently long pre-establish-communication zone should be set up for remote downloading.

Alternatively, large-capacity wireless coverage should be added in specific zones, such as cross-line interface stations between two lines. Through an access-restricted Wifi system or a future private 5G system, the communication performance can be greatly improved, the system performance can be ensured, and the best user experience can be provided.

### III. Scenario Description

Update in depot or parking lot of current line

The update in the depot refers to the process where the train performs data downloading and verification of a daily operation line before operation and then goes into operation on the line. The specific process is as follows:

After powering on in the depot, the VOBC acquires its location through a sleep-wake balise and performs version verification with the DSU of the line to determine whether the data version in use is consistent with the authorized version in the DSU.

If the data versions are verified to be consistent, updating is skipped.

If the data versions are verified to be inconsistent, the VOBC automatically downloads the data version authorized by the DSU from the central download server.

If the VOBC can obtain a daily operation plan, it may download data along a route in advance. An automatic train supervision (ATS) system can issue a list of line numbers that the train may operate on that day to the VOBC according to the plan (a VOBC-ATS interface needs to be added).

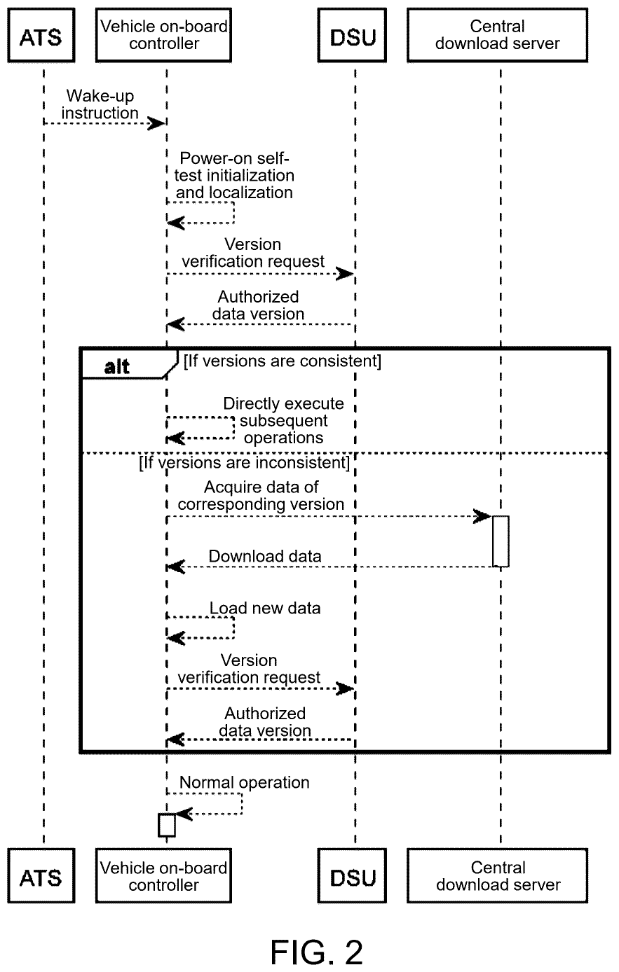

For a data flow diagram, reference is made to FIG. 2.

### Map Updating Before Cross-Line Operation

Downloading before line crossing refers to an update method in which the VOBC downloads downstream line data in advance during normal operation. The specific process is as follows:

When the VOBC determines that it is about to enter a next line (zone), it can establish communication with a DSU of the next line in advance and perform version verification.

If the verification fails, it should download the data version authorized by the DSU from the central download server.

If the verification passes, downloading is skipped.

Considering the time required for data downloading, verification, and loading, the pre-establish-communication zone (e.g., a platform including the boundary, or a farther place) can be set up at the line boundary, enabling the VOBC to establish communication and download data in advance.

A data download area can be defined in the interoperable electronic map.

The VOBC can determine the required line data based on a destination platform issued by the ATS system.

In the case of crossing multiple lines, the ATS system can inform the VOBC.

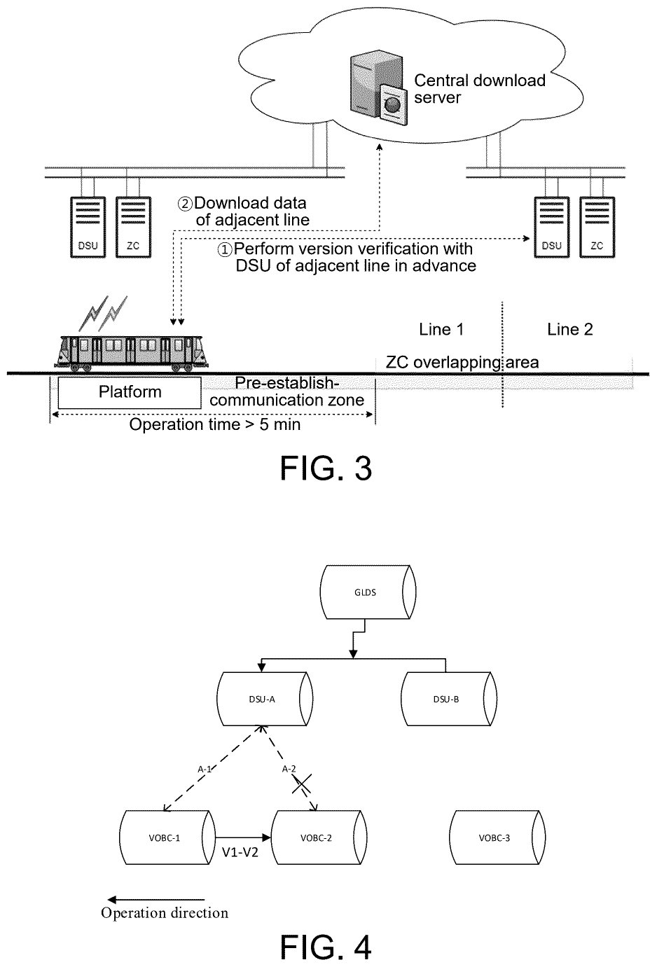

A schematic diagram of message updating before line crossing is as shown in FIG. 3. When the VOBC is about to cross the line (known through an ATS task), if the pre-establish-communication zone defined in the electronic map has been reached, communication with a DSU of an adjacent line is initiated, and data version verification is performed. If it is found that the versions are inconsistent, the operation of updating the data from the central download server can be performed. The setting of the pre-establish-communication zone should ensure that under normal operation conditions (including platform stopping time), the train has enough time to complete downloading and data updating before entering the overlapping area of the ZC crossing the line.

### Downgrading or Failure Scenario Application

Data updating under different downgrading conditions needs to be considered:

If it is known before operation that there is a communication failure on a main line but the communication in the depot is normal, downloading and verification need to be completed in the depot before switching to the backup mode for operation.

Process assurance is required: The line data cannot be updated during operation. The system should have a DSU-GLDS reverse locking mechanism.

If a DSU failure occurs suddenly during main-line operation, since the data of the current line has been verified previously and the reverse locking mechanism ensures that the trackside data will not be updated during operation, the operation can continue before the VOBC is restarted.

If there is no communication on the current line, the adjacent line needs to be entered for operation, and communication is available on the adjacent line, the data can be verified with the DSU of the adjacent line, then the train can switch to CBTC for normal operation on the adjacent line or the data is dynamically downloaded at the interface station, and the adjacent line is entered for operation after version verification by the DSU.

If there is no communication on both the current line and the adjacent line, the cross-line operation in the backup mode can only be performed. Manual assurance is required to ensure that the data version used by the on-board equipment is consistent with the data version of the trackside equipment.

### IV. Line Data Update Method Based on Train-to-Train Communication

### Downloading of Map Data Based on Train-to-Train Communication

If a latest signaling system standard and a moving block system based on train-to-train communication are introduced into an urban railway project, since the above system provides a secure and reliable data channel for direct train-to-train communication and offers technical feasibility in terms of communication capacity, based on the assumptions that a communication path between a front train and a rear train is optimal and a map of the front train is a map that the rear train will soon use, data transfer of map data after security verification at multiple reliable nodes such as a GDLS, a DSU, and a VOBC can be achieved through train-to-train communication.

During initialization of the VOBC, when the GLDS is busy, before cross-line operation of a VOBC train with un-updated map data, after GLDS equipment malfunctions, or in a user-defined scenario, the rear train can choose to directly request to obtain the latest data from the front train, thereby shortening the time for centralized downloading from the GDLS and the waiting time. Especially during peak hours, such as morning train wake-up time, the time cost for downloading data of a single train can be greatly reduced.

As shown in FIG. 4, when a channel A-2 malfunctions, a channel A-1 ensures communication with the DSU. On the premise of ensuring data reliability of a VOBC-1, reliable data can be provided for a VOBC-2 through channels V1-V2, and the VOBC-2 can be authorized to operate normally.

### Collaborative Verification Based on Multi-Node Secure and Reliable Devices

Under the architecture of the train-to-train communication system, after the latest line data of the GLDS is loaded and data refreshing and security verification of all reliable nodes on the line are completed, this function can ensure that in the case of a complete failure of the GDLS, a new VOBC can still acquire the latest data version and complete the security verification of multiple nodes, thus avoiding the subsequent system downgrading caused by global equipment failure. The VOBC of the train can obtain reliable map data from defined discrete data nodes (including the DSU of the current line, other on-board VOBCs, etc.), so that the train continues to be put into operation, thus improving the availability of a line operation service.

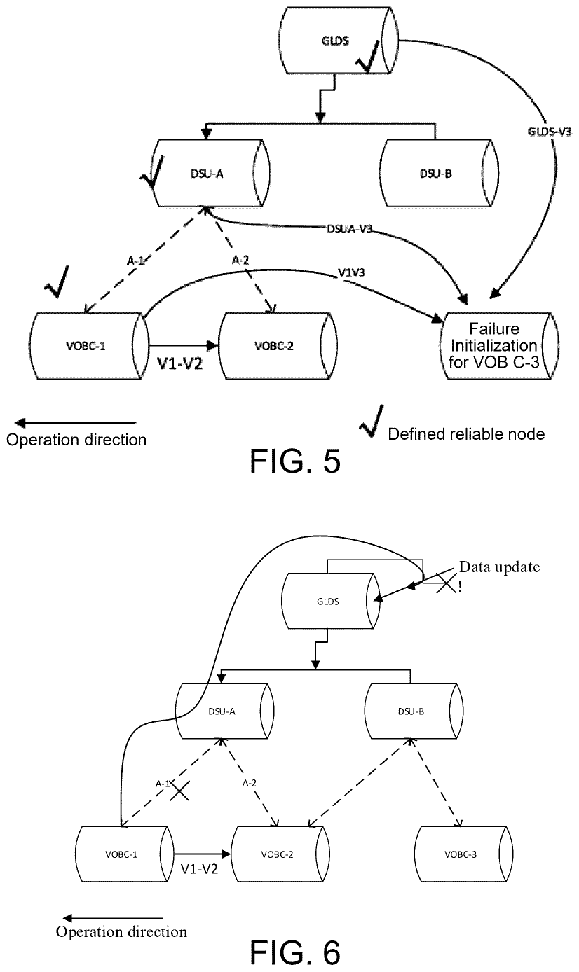

A schematic function is as shown in FIG. 5. A VOBC-3 serves as an initialization host. After startup, it acquires the statuses of the reliable nodes and the status of the reverse locking mechanism through a channel GLDS-V3, and can receive data verification information fed back by the reliable nodes DSU-A and VOBC-1. Through multiple data verifications, if the data verification of the reliable nodes passes, the updated line data can be used directly, and the train can be immediately put into operation. If there is a problem during the verification, the line map data can be quickly obtained from another reliable node, such as the front train, and the train can be put into operation after passing the verification.

### Reverse Locking Mechanism for Downloading of Line Map Data

According to the operational characteristics of the urban railway, the line data is usually updated during night maintenance window and is generally not replaced during operation. On the premise of such an assumption, a reverse locking mechanism can be introduced to ensure that the trackside data will not be incorrectly refreshed due to misoperation or human factors, thereby ensuring that in the case of a communication failure between the VOBC and the DSU, the data of the VOBC of the current train remains reliable and available. Alternatively, under the train-to-train communication mechanism, legal data is obtained from the reliable nodes such as the front train to avoid functional downgrading of the current train.

The reverse locking mechanism is implemented as follows: When a communication failure exceeding an allowable range of system security time occurs between a certain trackside reliable node (e.g., a DSU and a GLDS) in the system and a VOBC of a normally operating train, a hash value for global data protection will be verified and locked. At this time, under the action of a reliable locking protection mechanism, the system will be unable to update and synchronize data (this can also be implemented in a manner that the data fails the verification after storage and thus cannot be applied), thereby ensuring the system security in the case of failure.

The implementation principle is as shown in FIG. 6. When a wireless channel failure between the VOBC-1 and the DSU-A exceeds an allowable range of designed security time, failure status information is fed back to the GLDS via the DSU-A. At this time, verified hash will be unavailable, and the GLDS will lock the data updating and complete the protection of the existing data. The reverse locking mechanism for data updating ensures the reliability of the data throughout the entire line, and enhances the system availability and security.

The preferred specific embodiments of the present disclosure are described in detail above. It should be understood that those of ordinary skill in the art can make numerous modifications and variations according to the concept of the present disclosure without creative efforts. Therefore, any technical solutions that can be obtained by those skilled in the art according to the concept of the present disclosure through logical analysis, reasoning, or limited experiments on the basis of the prior art shall fall within the scope of protection defined by the claims.

1. A method for remotely updating and verifying map data of urban rail transit lines, applied in a vehicle on-board controller communicatively connected to a line data storage unit and a global download server separately, and comprising the following steps:
when a verification instruction is received, determining whether a data version in use is consistent with an authorized version stored in the line data storage unit: if the data version in use is consistent with the authorized version, skipping updating; or if the data version in use is not consistent with the authorized version, automatically downloading updated map data corresponding to the authorized version, wherein the updated map data is stored in the global download server.

2. The method for remotely updating and verifying map data of the urban rail transit lines according to claim 1, wherein the verification instruction is generated during power-on process or before cross-line operation.

3. The method for remotely updating and verifying map data of the urban rail transit lines according to claim 2, wherein during the power-on process, verification is performed only by comparing with the authorized version stored in a line data storage unit of a current line.

4. The method for remotely updating and verifying map data of the urban rail transit lines according to claim 3, wherein during the power-on process, it is determined whether operation plan information is received: if the operation plan information is received, verification is performed by comparing with the authorized version stored in a line data storage unit of a line along a route based on the operation plan information.

5. The method for remotely updating and verifying map data of the urban rail transit lines according to claim 2, wherein before the cross-line operation, it is determined whether a pre-establish-communication zone is reached: if the pre-establish-communication zone is reached, verification is performed by comparing with the authorized version stored in a line data storage unit of a next line to be entered.

6. The method for remotely updating and verifying map data of the urban rail transit lines according to claim 1, further comprising a communication failure determination approach, which specifically comprises the following sub-steps:
1a): during operation, determining in real time whether a communication failure exists on a current line: if the communication failure exists on the current line, executing sub-step 1b); or if the communication failure does not exist on the current line, repeating sub-step 1a); and
1b): determining whether a failure exists on an adjacent line: if the failure exists on the adjacent line, entering a backup mode for cross-line operation; or if the failure does not exist on the adjacent line, entering the adjacent line for operation, and performing verification by comparing with the authorized version stored in a line data storage unit of the adjacent line.

7. The method for remotely updating and verifying map data of the urban rail transit lines according to claim 1, further comprising a train-to-train communication step, which specifically comprises the following sub-steps:
2a): determining whether a train-to-train communication mode is activated: if the train-to-train communication mode is activated, executing sub-step 2b); or if the train-to-train communication mode is not activated, repeating sub-step 2a); and
2b): sending a request to acquire latest map data to a front train, and updating data of a current train based on an obtained response from the front train.

8. The method for remotely updating and verifying map data of the urban rail transit lines according to claim 7, wherein in the train-to-train communication mode, statuses of reliable nodes are acquired, and it is determined whether the data version in use is consistent with the authorized version of any one of the reliable nodes: if the data version in use is consistent with the authorized version of any one of the reliable nodes, skipping updating; or if the data version in use is not consistent with the authorized version of any one of the reliable nodes, automatically downloading the updated map data corresponding to the authorized version from any one of the reliable nodes, wherein each of the reliable nodes comprises a line data storage unit of a current line or other vehicle on-board controllers.

9. The method for remotely updating and verifying map data of the urban rail transit lines according to claim 1, wherein when the global download server updates the map data, a latest data version of the updated map data is simultaneously stored in the line data storage unit.

10. The method for remotely updating and verifying map data of the urban rail transit lines according to claim 9, wherein when there exists a communication failure exceeding an allowable range of system security time, the global download server locks data updating.

11. The method for remotely updating and verifying map data of the urban rail transit lines according to claim 9, wherein during operation, the global download server locks data updating.

12. A vehicle on-board controller, comprising a memory and a processor, wherein the memory stores a computer program, and when the computer program is executed by the processor, the method for remotely updating and verifying map data of urban rail transit lines according to claim 1 is implemented.

13. A computer-readable storage medium, storing a computer program, wherein when the computer program is executed by one or more processors, the method for remotely updating and verifying map data of urban rail transit lines according to claim 1 is implemented.

14. A system for remotely updating and verifying map data of urban rail transit lines, comprising a vehicle on-board controller, a line data storage unit, and a global download server, the vehicle on-board controller being communicatively connected to the line data storage unit and the global download server separately, wherein
the global download server is configured to store latest map data;
the line data storage unit is configured to store a latest data version of the map data, wherein the latest data version is an authorized version; and
the vehicle on-board controller is configured to determine, when receiving a verification instruction, whether a data version in use is consistent with the authorized version stored in the line data storage unit: if the data version in use is consistent with the authorized version stored in the line data storage unit, skip updating; or if the data version in use is not consistent with the authorized version stored in the line data storage unit, automatically download updated map data corresponding to the authorized version from the global download server.

15. The system for remotely updating and verifying map data of the urban rail transit lines according to claim 14, wherein a unique line data storage unit is set up for each line, and the vehicle on-board controller, before cross-line operation, determines whether a pre-establish-communication zone is reached: if the pre-establish-communication zone is reached, verification is performed by comparing with an authorized version stored in a line data storage unit of a next line to be entered.

16. The system for remotely updating and verifying map data of the urban rail transit lines according to claim 14, wherein the vehicle on-board controller has a train-to-train communication mode in which a request to acquire the latest map data is sent to a front train, and data of a current train is updated based on an obtained response from the front train.

17. The system for remotely updating and verifying map data of the urban rail transit lines according to claim 16, wherein in the train-to-train communication mode, the vehicle on-board controller acquires statuses of reliable nodes and determines whether the data version in use is consistent with an authorized version of any one of the reliable nodes: if the data version in use is consistent with the authorized version of any one of the reliable nodes, updating is skipped; or if the data version in use is not consistent with the authorized version of any one of the reliable nodes, the updated map data corresponding to the authorized version is automatically downloaded from any one of the reliable nodes, wherein each of the reliable nodes comprises a line data storage unit of a current line or other vehicle on-board controllers.

18. The system for remotely updating and verifying map data of the urban rail transit lines according to claim 14, wherein when there exists a communication failure exceeding an allowable range of system security time, the global download server locks data updating.

19. The system for remotely updating and verifying map data of the urban rail transit lines according to claim 14, wherein during operation, the global download server locks data updating.

20. The system for remotely updating and verifying map data of the urban rail transit lines according to claim 14, wherein the vehicle on-board controller, the line data storage unit, and the global download server achieve communication via a WiFi network or a 5G network.
